(19) United States
(12) Patent Application Publication
(10) Pub. No.: US 2025/0149722 A1
(43) Pub. Date: May 8, 2025

(54) POWER STORAGE DEVICE AND METHOD OF MANUFACTURING POWER STORAGE DEVICE

(71) Applicant: TOYOTA JIDOSHA KABUSHIKI KAISHA, Aichi-ken (JP)

(72) Inventors: Eiji YOSHIDA, Seto-shi (JP); Ryuma OSAKA, Toyota-shi (JP); Masaki SHIMADA, Kariya-shi (JP)

(21) Appl. No.: 18/904,085

(22) Filed: Oct. 2, 2024

(30) Foreign Application Priority Data
Oct. 13, 2023 (JP) 2023-177360

(51) Int. Cl. H01M 50/291; H01M 50/242; H01M 50/293; H01M 50/627

(52) U.S. Cl. CPC H01M 50/291; H01M 50/242; H01M 50/293; H01M 50/627

(57) ABSTRACT

A power storage device includes a power storage module including a plurality of power storage cells, an accommodation case, and a spacer. The accommodation case includes a pair of sidewalls. The spacer is arranged between at least one of the pair of sidewalls and the power storage module. The power storage module includes an opposing portion opposed to at least one of the pair of sidewalls. The spacer includes an elastic first member and a second member higher in modulus of elasticity than the first member. The first member includes a first line portion that continuously extends to form a holding region where the second member can be held. The second member is filled in the holding region. The first member and the second member are sandwiched between at least one of the pair of sidewalls and the opposing portion.

### CROSS REFERENCE TO RELATED APPLICATIONS

This nonprovisional application is based on Japanese Patent Application No. 2023-177360 filed with the Japan Patent Office on Oct. 13, 2023, the entire contents of which are hereby incorporated by reference.

### BACKGROUND

### Field

The present disclosure relates to a power storage device and a method of manufacturing a power storage device.

### Description of the Background Art

Conventionally, Japanese Patent Laying-Open No. 2022-153540 discloses a battery pack (power storage device) in which a cell array (power storage module) where a plurality of cells are aligned is accommodated in a tray (accommodation case) including a pair of side beams (sidewalls) opposed to each other along a longitudinal direction of the cell array and an elastic apparatus is provided between each of the pair of side beams and the cell array.

The elastic apparatus is attached to the side beam such that a distance of attachment thereof from each side beam is variable. The number of cells arranged between the pair of side beams can hence be adjusted by changing the distance of attachment without changing a pitch between the pair of side beams.

### SUMMARY

In a construction in Japanese Patent Laying-Open No. 2022-153540, however, when cell arrays are varied in length due to manufacturing tolerance of the cells, the distance of attachment of the elastic apparatus is varied depending on this variation. Therefore, efficiency in works for assembly of the battery pack becomes low and efficiency in manufacturing becomes low.

When the distance of attachment is not varied with the variation, on the other hand, a gap is provided between the cell array and the tray. The cell array thus expands and deforms due to heat generation or the like, and the cell array deteriorates.

The present disclosure was made in view of the problem as above, and an object of the present disclosure is to provide a power storage device and a method of manufacturing a power storage device that can achieve suppression of expansion of a power storage module regardless of variation in length of the power storage module.

A power storage device based on the present disclosure includes a power storage module including a plurality of power storage cells aligned in a first direction, an accommodation case where the power storage module is accommodated, and a spacer arranged between the power storage module and the accommodation case. The accommodation case includes a pair of sidewalls opposed to each other in the first direction. The spacer is arranged between at least one of the pair of sidewalls and the power storage module. The power storage module includes an opposing portion opposed to at least one of the pair of sidewalls in the first direction. The spacer includes an elastic first member and a second member higher in modulus of elasticity than the first member. The first member includes a first line portion that continuously extends to form a holding region where the second member can be held. The second member is filled in the holding region.

The first member and the second member are sandwiched between at least one of the pair of sidewalls and the opposing portion.

According to the above construction, while the second member is filled in the holding region partitioned by the first line portion of the elastic first member, the first member and the second member are sandwiched between the sidewall of the accommodation case and the opposing portion of the power storage module. The second member is thus filled in the holding region, so that a gap among the accommodation case, the sidewall, and the opposing portion of the power storage module can reliably be buried in the holding region even when lengths of the power storage modules are varied along the first direction. Consequently, expansion of the power storage module can be suppressed and deterioration of the power storage module can be suppressed.

In the power storage device based on the present disclosure, the accommodation case may include a bottom wall portion that supports the power storage module. The first line portion may be in a U shape that opens toward a side opposite to a side where the bottom wall portion is located.

According to the above construction, the second member can more reliably be held on an inner side of the first member. Provision of a gap between the sidewall of the accommodation case and the opposing portion of the power storage module in the holding region can thus be suppressed.

In the power storage device based on the present disclosure, the first line portion may include a pair of ends distant from each other on the side opposite to the side where the bottom wall portion is located. The first member may include a second line portion that extends from one end side of the pair of ends toward the other end side of the pair of ends.

According to the above construction, the second line portion is provided so that the second member can more reliably be held in the holding region. Provision of a gap between the sidewall of the accommodation case and the opposing portion of the power storage module in the holding region can thus be suppressed.

In the power storage device based on the present disclosure, the first line portion may include a pair of first extension portions that is arranged as being aligned at a distance in a second direction orthogonal to the first direction and a direction perpendicular to the bottom wall portion and extends along the direction perpendicular to the bottom wall portion, a second extension portion that extends along the second direction on a side of the bottom wall portion relative to the pair of first extension portions, and a corner portion that connects an end of each of the pair of first extension portions located on the side of the bottom wall portion and the second extension portion to each other. The corner portion may include an inner curved portion that forms a part of an inside edge portion of the U shape and an outer curved portion that forms a part of an outside edge portion of the U shape.

According to the above construction, the corner portion is provided with the inner curved portion and the outer curved portion, so that a shape of the first member can be stabilized. Since the second member is filled in the holding region as extending along the inner curved portion, provision of a gap in the vicinity of the corner portion can be suppressed.

In the power storage device based on the present disclosure, the inner curved portion may be larger in radius of curvature than the outer curved portion.

According to the above construction, the shape of the corner portion becomes large and the shape of the first member can further be stabilized. Leakage of the second member from the holding region to the outside can thus further be suppressed.

In the power storage device based on the present disclosure, the second member may include a portion that continuously extends along an inner edge portion of the first line portion.

According to the construction, the first member can suppress displacement of the second member in the direction perpendicular to the first direction. Displacement of the second member in the first direction can thus be made smaller and expansion of the power storage module can suitably be suppressed.

A method of manufacturing a power storage device based on the present disclosure includes preparing a case member including a pair of sidewalls opposed to each other in a first direction and a bottom wall portion to which the pair of sidewalls is connected, arranging a power storage module including a plurality of power storage cells aligned in the first direction on the bottom wall portion, and providing a spacer for suppression of expansion of the power storage module between at least one of the pair of sidewalls and the power storage module. The providing a spacer includes providing an elastic first member and providing a second member higher in modulus of elasticity than the first member. The providing an elastic first member includes expanding the first member provided as being expandable at an opposing portion of the power storage module opposed to at least one of the pair of sidewalls in the first direction. In the expanding the first member, the first member is expanded to form a holding region where the second member in a fluid state can be held. The providing a second member includes filling the second member in the fluid state in the holding region and solidifying the second member in the fluid state. The first member and the second member are formed as being sandwiched between at least one of the pair of sidewalls and the opposing portion.

According to the above construction, by expanding the first member, the first member and the sidewall of the case member can be brought in contact with each other. By filling the second member in the fluid state in the holding region formed (partitioned) by the expanded first member and solidifying the second member in the fluid state in this state, the second member can bury a gap between the opposing portion of the power storage module and the sidewall of the accommodation case in the holding region. Even when lengths of the power storage modules along the first direction are varied, a gap among the accommodation case, the sidewall, and the opposing portion of the power storage module in the holding region can thus reliably be buried. Consequently, expansion of the power storage module can be suppressed and deterioration of the power storage module can be suppressed.

In the method of manufacturing a power storage device in the present disclosure, the first member may be provided at the opposing portion to include a first line portion in a U shape that opens toward a side opposite to a side where the bottom wall portion is located.

According to the above construction, leakage of the second member in the fluid state to the outside of the holding region can be suppressed, and the second member can more reliably be held on the inner side of the first member. Provision of a gap between the sidewall of the accommodation case and the opposing portion of the power storage module in the holding region can thus be suppressed.

In the method of manufacturing a power storage device in the present disclosure, the first member may be formed to include the first line portion in the U shape including a pair of ends located as being distant from each other on the side opposite to the side where the bottom wall portion is located and a second line portion that extends from one end side of the pair of ends toward the other end side of the pair of ends.

According to the above construction, the second line portion is provided so that leakage of the second member in the fluid state to the outside of the holding region can further be suppressed. The second member can thus more reliably be held in the holding region, and consequently provision of a gap between the sidewall of the accommodation case and the opposing portion of the power storage module in the holding region can be suppressed.

In the method of manufacturing a power storage device based on the present disclosure, the first line portion may be provided to include a pair of first extension portions that is arranged as being aligned at a distance in a second direction orthogonal to the first direction and a direction perpendicular to the bottom wall portion and extends along the direction perpendicular to the bottom wall portion, a second extension portion that extends along the second direction on a side of the bottom wall portion relative to the pair of first extension portions, and a corner portion that connects an end of each of the pair of first extension portions located on the side of the bottom wall portion and the second extension portion to each other. The corner portion may be provided to include an inner curved portion that forms a part of an inside edge portion of the U shape and an outer curved portion that forms a part of an outside edge portion of the U shape.

According to the above construction, force applied to the corner portion in expansion of the first member can substantially be uniform, and the first member can substantially uniformly be expanded. Provision in part of a portion where expansion is insufficient in the first member can thus be prevented and the shape of the first member can be stabilized. Therefore, leakage of the second member in the fluid state to the outside of the holding region can be suppressed and the second member can more reliably be held on the inner side of the first member. In addition, since the second member in the fluid state is filled in the holding region as extending along the inner curved portion, provision of a gap in the vicinity of the corner portion can be suppressed. Consequently, provision of a gap between the sidewall of the accommodation case and the opposing portion of the power storage module in the holding region can be suppressed.

In the method of manufacturing a power storage device based on the present disclosure, the inner curved portion may be larger in radius of curvature than the outer curved portion.

According to the above construction, the shape of the corner portion becomes large and the shape of the first member can further be stabilized. Leakage of the second member in the fluid state from the holding region to the outside can thus further be suppressed. Consequently, provision of a gap between the sidewall of the accommodation case and the opposing portion of the power storage module in the holding region can be suppressed.

In the method of manufacturing a power storage device based on the present disclosure, in the preparing a case member, the case member provided with a through hole that passes through in the first direction in a portion of at least one of the pair of sidewalls opposed to the holding region may be prepared. In the filling the second member in the fluid state, the second member in the fluid state may be injected into the holding region through the through hole.

According to the above construction, ease in injection of the second member in the fluid state can be enhanced.

In the method of manufacturing a power storage device based on the present disclosure, the arranging a power storage module on the bottom wall portion may include applying an adhesive to at least a part of an opposing surface of the power storage module to be opposed to the bottom wall portion and pressing the power storage module relatively against the bottom wall portion with the adhesive being interposed. In the expanding the first member, the first member may be expanded as being distant from the adhesive

According to the above construction, adhesion of the adhesive to the first member and resultant interference with expansion of the first member can be prevented.

In the method of manufacturing a power storage device based on the present disclosure, in a state before expansion of the first member, the first member may be located at a prescribed distance from the bottom wall portion. The prescribed distance may be at least 0.8% and at most 8% of a height of the power storage cells in a direction perpendicular to the bottom wall portion.

According to the above construction, contact between the first member and the adhesive can be prevented. Adhesion of the adhesive to the first member and resultant interference with expansion of the first member can thus be prevented.

In the method of manufacturing a power storage device based on the present disclosure, in the arranging a power storage module on the bottom wall portion, the first member may be provided at the opposing portion of the power storage module, as being sealed at a barometric pressure lower than an atmospheric pressure by a sealing member. In the expanding the first member, the first member may be expanded by providing an opening in the sealing member

According to the construction, in arrangement of the power storage module on the bottom wall portion, the elastic first member sealed at a low barometric pressure maintains a state compressed by the atmospheric pressure. Therefore, while interference between the sidewall and the first member is suppressed, the power storage module can readily be arranged on the bottom wall portion. In addition, the first member can readily be expanded by providing an opening in the sealing member. Since the holding region is formed by intimate contact of the expanded first member with the sidewall, spill of the second member in the fluid state from the holding region in injection of the second member in the fluid state into the holding region can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic plan view of a power storage device according to an embodiment.

FIG. 2 is a perspective view showing a structure around an opposing portion of a power storage module in the power storage device according to the embodiment.

FIG. 3 is a diagram showing a construction in the vicinity of a corner portion of a first member according to the embodiment.

FIG. 4 is a diagram showing a modification of the corner portion of the first member.

FIG. 5 is a flowchart showing a process of manufacturing a power storage device according to the embodiment.

FIG. 6 is a diagram showing a step of applying an adhesive in the process of manufacturing a power storage device shown in FIG. 5.

FIG. 7 is a diagram showing a step of pressing the power storage module relatively against a bottom wall portion in the process of manufacturing a power storage device shown in FIG. 5.

FIG. 8 is a diagram showing a step of expanding the first member in the process of manufacturing a power storage device shown in FIG. 5.

FIG. 9 is a diagram showing a step of filling a second member in a fluid state in the process of manufacturing a power storage device shown in FIG. 5.

FIG. 10 is a diagram showing a state following a step of solidifying the second member in the fluid state in the process of manufacturing a power storage device shown in FIG. 5.

### DESCRIPTION OF THE PREFERRED EMBODIMENTS

An embodiment of the present disclosure will be described in detail below with reference to the drawings. The same or common elements in the embodiment shown below have the same reference characters allotted in the drawings and description thereof will not be repeated.

### (Power Storage Device)

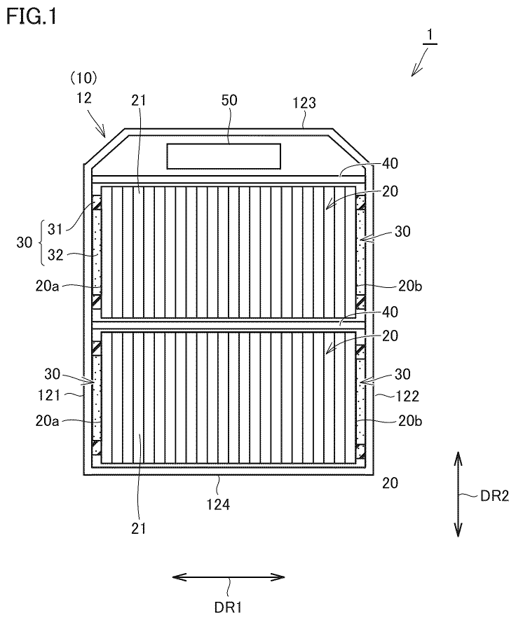

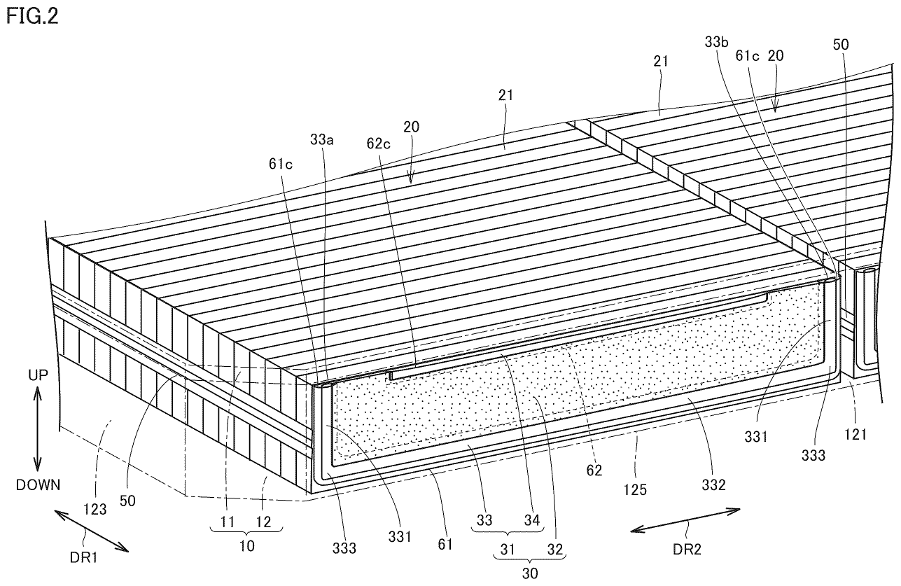

FIG. 1 is a schematic plan view of a power storage device according to an embodiment. FIG. 1 does not show an upper case of an accommodation case for the sake of convenience. FIG. 2 is a perspective view showing a structure around an opposing portion of a power storage module in the power storage device according to the embodiment. FIG. 2 shows the accommodation case with a chain dotted line for the sake of convenience. A power storage device 1 according to the embodiment will be described with reference to FIGS. 1 and 2.

Power storage device 1 according to the embodiment is mounted, for example, on a hybrid electric vehicle that can travel with motive power from at least one of a motor and an engine or an electrically powered vehicle that travels with drive force obtained from electric energy. Power storage device 1 is provided below a floor panel of a vehicle. A position of placement of power storage device 1 in the vehicle is not limited as above, and the power storage device may be arranged, for example, between the floor panel and a seat.

As shown in FIG. 1, power storage device 1 includes an accommodation case 10, a plurality of power storage modules 20, a plurality of spacers 30, and an electronic device 50.

The plurality of power storage modules 20 and the plurality of spacers 30 are accommodated in accommodation case 10. Accommodation case 10 includes an upper case 11 (see FIG. 2) and a lower case 12 opposed to each other in an upward/downward direction. The upward/downward direction is a direction orthogonal to a first direction (DR1 direction) which will be described later, and it is a direction perpendicular to a bottom wall portion 125 (see FIG. 2) of lower case 12.

Lower case 12 is substantially in a box shape that opens upward. Lower case 12 is formed, for example, of a metallic material such as an aluminum alloy. Lower case 12 includes bottom wall portion 125 (see FIG. 2), a pair of sidewalls 121 and 122, a first wall portion 123, and a second wall portion 124.

The pair of sidewalls 121 and 122 is opposed to each other in the first direction. The first direction refers, for example, to a direction in parallel to a width direction of the vehicle in a mount state in which power storage device 1 is mounted on the vehicle. First wall portion 123 and second wall portion 124 are opposed to each other in a second direction (DR2 direction). The second direction is a direction orthogonal to the first direction and the upward/downward direction. The second direction is, for example, a direction in parallel to a front-rear direction of the vehicle in the mount state.

The pair of sidewalls 121 and 122, first wall portion 123, and second wall portion 124 are connected to a periphery of bottom wall portion 125 to form a peripheral wall portion of lower case 12.

Upper case 11 is provided to cover an opening of lower case 12 that opens upward. Upper case 11 may be formed of a metallic material such as an aluminum alloy, or of resin or the like. In an example where upper case 11 is formed of resin, accommodation case 10 can be reduced in weight.

A plurality of partition members 40 are provided in accommodation case 10. Each of the plurality of partition members 40 extends along the first direction. The plurality of partition members 40 are arranged at a distance in the second direction to partition a region where power storage modules 20 are arranged. Partition member 40 may be provided with a support member that supports the upper case.

The plurality of power storage modules 20 are arranged in regions partitioned by partition members 40 in accommodation case 10. Power storage module 20 is fixed to bottom wall portion 125, for example, with a thermally conductive adhesive 70 (see FIG. 7).

The plurality of power storage modules 20 are arranged as being aligned at a distance in the second direction. In a gap between power storage modules 20 adjacent to each other, partition member 40 is arranged. Though an example in which two power storage modules 20 are arranged as being aligned in the second direction is exemplified in the present embodiment, a single power storage module 20 or at least three power storage modules 20 may be provided.

The plurality of power storage modules 20 each include a plurality of power storage cells 21 aligned in the first direction. Power storage cell 21 is a secondary battery such as a nickel metal hydride battery or a lithium ion battery. Power storage cell 21 is, for example, in a prismatic shape. The secondary battery may contain a liquid electrolyte or a solid electrolyte.

Power storage module 20 includes opposing portions 20a and 20b opposed to the pair of sidewalls 121 and 122 in the first direction. Opposing portion 20a (a first opposing portion) is opposed to sidewall 121. Opposing portion 20b (a second opposing portion) is opposed to sidewall 122.

The plurality of power storage modules 20 may each include a pair of end plates or a plurality of spacers and an insulating film and the like, and opposing portions 20a and 20b are composed of members located at opposing ends in the first direction of power storage module 20.

Electronic device 50 is arranged on one side in the second direction in accommodation case 10. Electronic device 50 may include, for example, a battery ECU and a battery management system (BMS). One side in the second direction refers to a front side of the vehicle in the mount state.

Spacer 30 is arranged in a gap between power storage module 20 and accommodation case 10. Spacer 30 suppresses, for example, expansion of power storage module 20. In the present embodiment, two spacers 30 are arranged in respective gaps between power storage module 20 and accommodation case 10.

Specifically, spacer 30 is arranged in a gap between sidewall 121 and opposing portion 20a and spacer 30 is arranged in a gap between sidewall 122 and opposing portion 20b.

Spacer 30 includes a first member 31 and a second member 32. First member 31 is elastic. First member 31 is composed, for example, of a foam member such as sponge. Second member 32 is higher in modulus of elasticity than the first member. A resin member such as phenol and urethane or an adhesive layer resulting from solidification of an adhesive such as a urethane-based adhesive and a silicon-based adhesive can be adopted as second member 32. An adhesive curable at room temperature can be adopted. In this case, influence of heat on power storage module 20 can be lessened, and hence expansion of power storage module 20 can be suppressed.

First member 31 and second member 32 are sandwiched between sidewall 121 and opposing portion 20a on one side in the first direction. First member 31 and second member 32 are sandwiched between sidewall 122 and opposing portion 20b on the other side in the first direction.

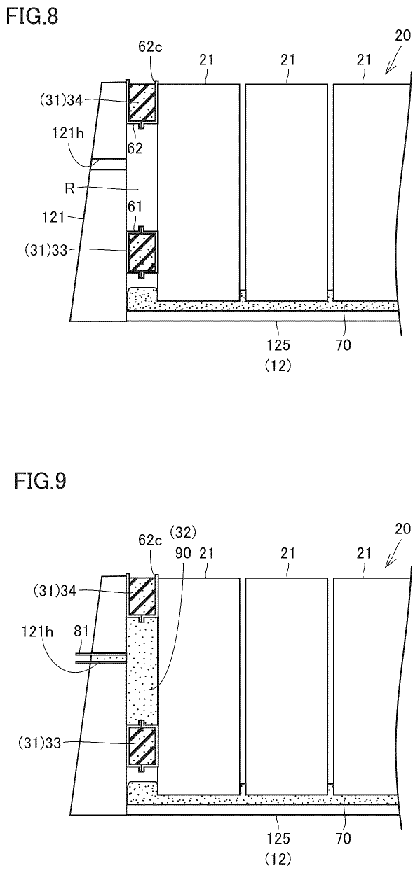

As shown in FIG. 2, first member 31 includes a first line portion 33 and a second line portion 34. First line portion 33 continuously extends to form a holding region R (see FIG. 8) where second member 32 can be held.

Specifically, first line portion 33 is in a U shape that opens upward. Thus, on an inner side of first line portion 33, downward movement of second member 32 is suppressed and second member 32 can be held. First line portion 33 is provided along a peripheral portion of each of opposing portions 20a and 20b.

First line portion 33 includes a pair of first extension portions 331, a second extension portion 332, and a corner portion 333. The pair of first extension portions 331 is arranged as being aligned at a distance in the second direction and extends along the direction perpendicular to bottom wall portion 125. Second extension portion 332 extends along the second direction on a side of bottom wall portion 125 relative to the pair of first extension portions 331. Corner portion 333 connects an end of each of the pair of first extension portions 331 located on the side of bottom wall portion 125 and second extension portion 332 to each other.

First line portion 33 includes a pair of ends 33a and 33b distant from each other on a side opposite to a side where bottom wall portion 125 is located. First line portion 33 is covered with a sealing member 61 provided with an opening 61c. Opening 61c is provided at a position corresponding to each of the pair of ends 33a and 33b. Air enters sealing member 61 through opening 61c.

Second line portion 34 extends from one end 33a toward the other end 33b of the pair of ends 33a and 33b. Second line portion 34 extends along the second direction. Second line portion 34 is arranged at a distance from the pair of first extension portions 331, and gaps are provided between second line portion 34 and the pair of first extension portions 331. Second line portion 34 does not have to be provided. An upper end of second line portion 34 may protrude upward from a side of power storage cell 21 that is located opposite to bottom wall portion 125 and extends in a longitudinal direction (second direction) when viewed from the first direction. In this case, input of load onto an upper surface of power storage module 20 can be suppressed. The upper end of second line portion 34 may be located at a height position as high as the side of power storage cell 21 that is located opposite to bottom wall portion 125 and extends in the longitudinal direction (second direction) when viewed from the first direction, or may be located below this side.

Second member 32 is filled in holding region R defined by first line portion 33. Holding region R is a space surrounded by first line portion 33 and located between sidewall 121 and opposing portion 20a on one side in the first direction and a space surrounded by first line portion 33 and located between sidewall 122 and opposing portion 20b on the other side in the first direction. Holding region R is not limited as above, and it may be a region that faces a central portion in the longitudinal direction (second direction) of power storage cell 21 when viewed from the first direction and has an appropriate shape that allows holding of second member 32. Holding region R may be a region that faces a central portion in a direction of a short side (upward/downward direction) of power storage cell 21 when viewed from the first direction and has an appropriate shape that allows holding of second member 32. First line portion 33 can be in an appropriate shape in conformity with holding region R in the appropriate shape. Second member 32 includes a portion that continuously extends along an inner edge portion of first line portion 33.

Second line portion 34 is covered with a sealing member 62 provided with an opening 62c. Opening 62c is provided to extend in the second direction on an upper end side of sealing member 62. Air enters sealing member 62 through opening 62c.

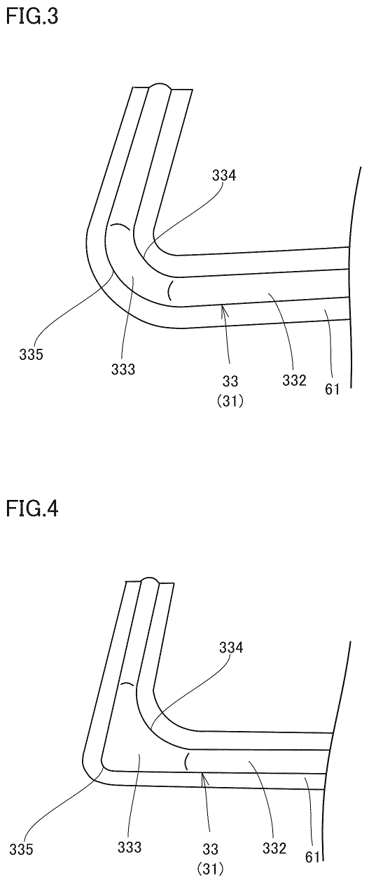

FIG. 3 is a diagram showing a construction in the vicinity of the corner portion of the first member according to the embodiment. As shown in FIG. 3, corner portion 333 includes an inner curved portion 334 that forms a part of an inside edge portion of the U shape and an outer curved portion 335 that forms a part of an outside edge portion of the U shape. In the embodiment, inner curved portion 334 and outer curved portion 335 are substantially equal to each other in radius of curvature.

FIG. 4 is a diagram showing a modification of the corner portion of the first member. As shown in FIG. 4, at corner portion 333, inner curved portion 334 may be larger in radius of curvature than outer curved portion 335.

As set forth above, in power storage device 1 according to the present embodiment, while second member 32 is filled in holding region R partitioned by first line portion 33 of elastic first member 31, first member 31 and second member 32 are sandwiched between sidewall 121 of accommodation case 10 and opposing portion 20a of power storage module 20 and between sidewall 122 of accommodation case 10 and opposing portion 20b of power storage module 20. As second member 32 is filled in holding region R, gaps between sidewalls 121 and 122 of accommodation case 10 and opposing portions 20a and 20b of power storage module 20 in holding regions R can reliably be buried even when the lengths of power storage modules 20 along the first direction are varied. Consequently, expansion of power storage module 20 can be suppressed and deterioration of power storage module 20 can be suppressed.

First line portion 33 is in the U shape that opens toward the side opposite to the side where bottom wall portion 125 is located, so that second member 32 can more reliably be held on the inner side of first member 31. Provision of gaps between sidewalls 121 and 122 and opposing portions 20a and 20b of power storage module 20 in holding regions R can thus be suppressed.

Furthermore, first member 31 includes second line portion 34 described above, so that second member 32 can more reliably be held in holding region R.

In addition, corner portion 333 of first line portion 33 includes inner curved portion 334 and outer curved portion 335 so that the shape of first member 31 can be stabilized. Since second member 32 is filled in holding region R along inner curved portion 334, provision of a gap in the vicinity of corner portion 333 can be suppressed.

When inner curved portion 334 is larger in radius of curvature than outer curved portion 335 as in the modification, the shape of corner portion 333 becomes large and the shape of first member 31 can further be stabilized. Leakage of second member 32 from holding region R to the outside can thus further be suppressed.

Furthermore, second member 32 includes a portion that continuously extends along the inner edge portion of first line portion 33, so that first member 31 can suppress displacement of second member 32 in the direction perpendicular to the first direction. Displacement of second member 32 in the first direction can thus be made smaller and expansion of power storage module 20 can suitably be suppressed.

### (Manufacturing Method)

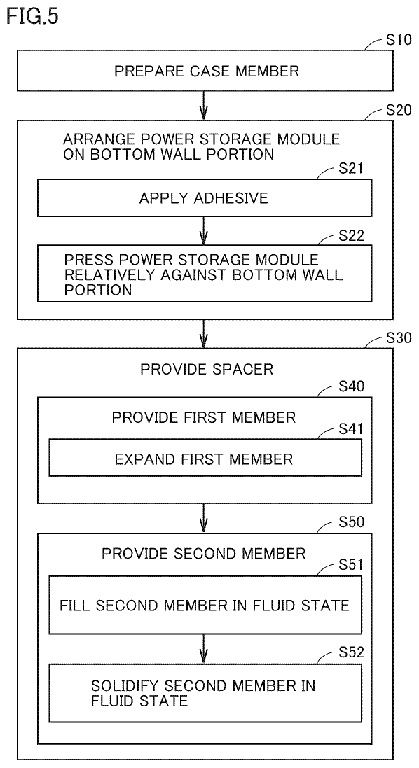

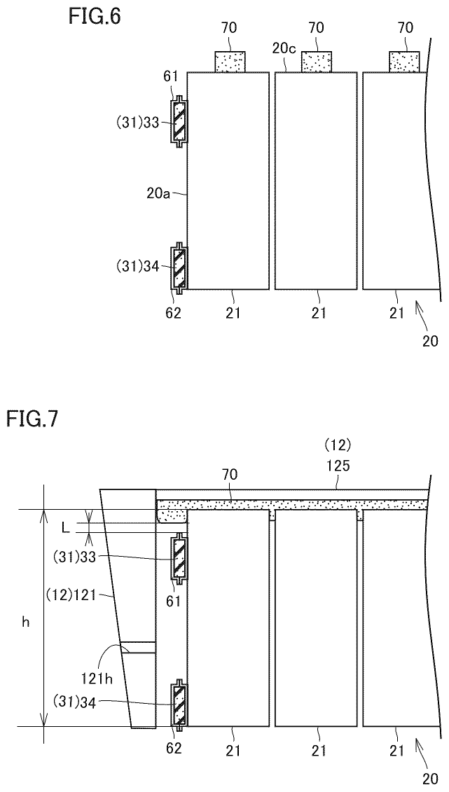

FIG. 5 is a flowchart showing a process of manufacturing a power storage device according to the embodiment. FIGS. 6 to 10 are diagrams showing prescribed steps in the manufacturing process shown in FIG. 5 and a state following the prescribed steps. The method of manufacturing power storage device 1 will be described with reference to FIGS. 5 to 10. Though FIGS. 6 to 10 show one side (the side of opposing portion 20a) in the first direction in power storage module 20 for the sake of convenience, contents similar to those on one side are performed also on the other side in the first direction. Therefore, contents on one side in the first direction will be described below and description of a state or the like on the other side in the first direction is not provided.

As shown in FIG. 5, the process of manufacturing power storage device 1 includes steps of preparing a case member (S10), arranging power storage module 20 on bottom wall portion 125 (S20), and providing spacer 30 (S30).

In manufacturing of power storage device 1, initially in the step (S10), the case member is prepared. Specifically, lower case 12 including the pair of sidewalls 121 and 122 and bottom wall portion 125 to which the pair of sidewalls 121 and 122 is connected is prepared as the case member. Through hole 121h is provided in sidewall 121. Similarly, a through hole is provided also in sidewall 122.

In succession, in the step (S20), power storage module 20 including a plurality of power storage cells 21 aligned in the first direction is arranged on bottom wall portion 125. The step (S20) includes steps of applying an adhesive (S21) and pressing power storage module 20 relatively against bottom wall portion 125 (S22).

FIG. 6 is a diagram showing the step of applying an adhesive in the process of manufacturing a power storage device shown in FIG. 5. As shown in FIGS. 5 and 6, in performing the step (S20), initially in the step (S21), adhesive 70 is applied to at least a part of an opposing surface 20c of power storage module 20 to be opposed to bottom wall portion 125. A thermally conductive adhesive may be employed as adhesive 70 so as to be able to cool power storage module 20 through bottom wall portion 125.

FIG. 7 is a diagram showing the step of pressing the power storage module relatively against the bottom wall portion in the process of manufacturing a power storage device shown in FIG. 5.

In succession, as shown in FIGS. 5 and 7, in the step (S22), power storage module 20 is pressed relatively against bottom wall portion 125 with adhesive 70 being interposed. Specifically, while bottom wall portion 125 is opposed to opposing surface 20c from above, power storage module 20 is pressed relatively against bottom wall portion 125 such that adhesive 70 spreads over the entire opposing surface 20c.

Opposing portion 20a opposed to sidewall 121 is provided with first member 31. Specifically, first member 31 is provided at opposing portion 20a so as to include first line portion 33 and second line portion 34.

First line portion 33 is in the U shape that opens toward the side opposite to the side where bottom wall portion 125 is located. Second line portion 34 extends from one end side to the other end side of the pair of ends of first line portion 33 located at a distance from each other on the side opposite to the side where bottom wall portion 125 is located. The end of second line portion 34 located on the side opposite to the side where bottom wall portion 125 is located may protrude from the side of power storage cell 21 that is located opposite to bottom wall portion 125 and extends in the longitudinal direction (second direction) toward the side opposite to the side where bottom wall portion 125 is located when viewed from the first direction. In this case, input of load to a main surface of power storage module 20 located opposite to bottom wall portion 125 can be suppressed. The end of second line portion 34 may be located at a height position as high as the side of power storage cell 21 that is located opposite to bottom wall portion 125 and extends in the longitudinal direction (second direction) when viewed from the first direction, or may be located on the side of bottom wall portion 125 relative to this side.

First line portion 33 is sealed at a barometric pressure lower than the atmospheric pressure by sealing member 61. Second line portion 34 is sealed at a barometric pressure lower than the atmospheric pressure by sealing member 62. In this state, openings 61c and 62c are not provided in sealing members 61 and 62, and first line portion 33 and second line portion 34 are hermetically sealed.

First member 31 (first line portion 33 and second line portion 34) is thus compressed, and interference of first member 31 with sidewall 121 in arrangement of power storage module 20 on bottom wall portion 125 can be suppressed.

First member 31 is arranged at a distance from adhesive 70 spread by being pressed. Specifically, first member 31 is located at a prescribed distance L from bottom wall portion 125. The prescribed distance is at least 0.8% and at most 8% of a height h of power storage cell 21 in the direction perpendicular to bottom wall portion 125.

With such positional relation, contact between adhesive 70 spread by being pressed and first member 31 can be prevented. Adhesion of adhesive 70 to first member 31 and resultant interference with expansion of first member 31 in a step (S41) which will be described later can thus be prevented.

In succession, as shown in FIG. 5, the step (S30) is performed to provide spacer 30 for suppression of expansion of power storage module 20 between sidewall 121 and power storage module 20.

The step (S30) includes steps of providing the first member (S40) and providing the second member (S50).

In performing the step (S30), initially, the step (S40) is performed to provide the elastic first member. The step (S40) includes the step of expanding the first member (S41).

FIG. 8 is a diagram showing the step of expanding the first member in the process of manufacturing a power storage device shown in FIG. 5.

As shown in FIGS. 5 and 8, in the step (S41), first member 31 provided as being expandable at opposing portion 20a of power storage module 20 opposed to sidewall 121 is expanded. Specifically, first member 31 is expanded by providing openings 61c (see FIG. 2) and 62c in sealing members 61 and 62. Openings 61c and 62c are provided by partially cutting sealing members 61 and 62 with a cutting member.

As described above, first line portion 33 and second line portion 34 are sealed at the low barometric pressure, and hence a compressed state thereof is maintained by the atmospheric pressure therearound. By providing openings 61c and 62c in sealing members 61 and 62, air enters sealing members 61 and 62 so that first line portion 33 and second line portion 34 can readily be expanded.

At this time, first line portion 33 and second line portion 34 are expanded as being distant from adhesive 70 described above. Adhesion of adhesive 70 to first member 31 and resultant interference with expansion of first member 31 can thus be prevented.

In the step (S41), first member 31 is expanded such that holding region R where a second member 90 (see FIG. 9) in a fluid state can be held is provided. Second member 90 in the fluid state is a liquid member such as a liquid resin member or a liquid adhesive. First member 31 is expanded such that the liquid member can be retained. As described above, for example, first member 31 includes first line portion 33 in the U shape that continuously extends, and by expanding first line portion 33 to be in intimate contact with sidewall 121, the liquid member can be retained in a space on the inner side of expanded first line portion 33.

Though an example in which first line portion 33 is in the U shape is exemplified in the embodiment, first line portion 33 may be in another shape so long as the first line portion comes in intimate contact with sidewall 121 to define the space where the liquid member can be retained.

When first line portion 33 is in the U shape as extending along the peripheral portion of opposing portion 20a, a large space (holding region R) on the inner side of first line portion 33 can be provided. Thus, by filling the second member in holding region R, expansion of power storage module 20 can effectively be suppressed.

By expanding also second line portion 34, leakage of second member 90 in the fluid state from holding region R in injection of second member 90 in the fluid state into holding region R can be suppressed. Furthermore, second line portion 34 is provided to define the gaps between second line portion 34 and the pair of ends of first line portion 33 located at a distance from each other on the side opposite to the side where bottom wall portion 125 is located. Therefore, in injection of second member 90 in the fluid state into holding region R, air can escape through the gaps.

In addition, first line portion 33 includes corner portion 333 as described above, and corner portion 333 includes inner curved portion 334 and outer curved portion 335. Therefore, in expansion of first line portion 33, force can be applied to corner portion 333 more uniformly than to a corner portion that is not curved, and first line portion 33 can uniformly be expanded. Locally insufficient expansion in a part of corner portion 333 can thus be suppressed. Consequently, provision of a gap between a portion where expansion is insufficient and sidewall 121 can be suppressed and leakage of the second member in the fluid state from the gap toward bottom wall portion 125 can be suppressed.

Inner curved portion 334 may be larger in radius of curvature than outer curved portion 335. In this case, the shape of corner portion 333 can be large and local application of force to corner portion 333 at the time of expansion can be suppressed. The shape of first line portion 33 can thus be stabilized. As the shape of corner portion 333 becomes large and is stabilized, intimate contact with sidewall 121 in corner portion 333 can be enhanced.

In succession, as shown in FIG. 5, the step (S50) is performed to provide second member 32. The step (S50) includes steps of filling second member 90 in the fluid state (S51) and solidifying second member 90 in the fluid state (S52).

FIG. 9 is a diagram showing the step of filling second member 90 in the fluid state in the process of manufacturing a power storage device shown in FIG. 5. As shown in FIGS. 5 and 9, in performing the step (S50), initially in the step (S51), second member 90 in the fluid state is injected into holding region R. Specifically, second member 90 in the fluid state is injected into holding region R through hole 121h that passes through in the first direction in the portion of sidewall 121 opposed to holding region R. More specifically, a pipe 81 is inserted in through hole 121h and second member 90 in the fluid state is caused to flow through pipe 81 to be injected into holding region R. As second member 90 in the fluid state is filled in holding region R, injection of second member 90 in the fluid state is stopped. After injection is completed, pipe 81 is removed from through hole 121h.

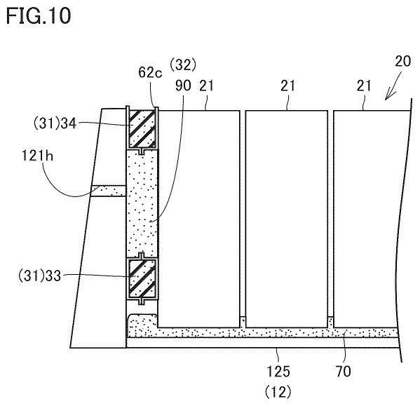

In succession, as shown in FIG. 5, in the step (S52), second member 90 in the fluid state is solidified. FIG. 10 is a diagram showing a state following the step of solidifying second member 90 in the fluid state in the process of manufacturing a power storage device shown in FIG. 5. As shown in FIG. 10, in an example where second member 90 in the fluid state is a member solidified at the room temperature, second member 90 in the fluid is solidified by being left at the room temperature for a prescribed time period to form second member 32. Second member 32 is higher in modulus of elasticity than first member 31, and second member 32 is formed over a wide range to fill the gap between sidewall 121 and opposing portion 20a. Expansion of power storage module 20 can thus effectively be suppressed.

Second member 90 in the fluid state may be thermosetting or photocurable. In this case, in order to cure second member 90 in the fluid state, second member 90 may be heated or irradiated with light.

In succession, the opening of lower case 12 is covered with upper case 11. Through the steps as above, power storage device 1 according to the embodiment can be manufactured.

### Other Modifications

Though the example in which spacer 30 is provided between each of the pair of sidewalls 121 and 122 and power storage module 20 is exemplified and described in the embodiment above, limitation as such is not intended. Spacer 30 may be provided between at least one of the pair of sidewalls 121 and 122 and power storage module 20. In this case again, the power storage device is manufactured in accordance with the manufacturing method above.

Though the example in which the through hole is provided in the pair of sidewalls 121 and 122 and the second member in the fluid state is injected through the through hole into holding region R in the step (S51) is exemplified and described in the embodiment above, limitation as such is not intended. In an example where the through hole is not provided in the pair of sidewalls 121 and 122, the second member in the fluid state may be injected through gaps between the pair of ends 33a and 33b of first line portion 33 and second line portion 34.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a power storage module including a plurality of power storage cells aligned in a first direction;
an accommodation case where the power storage module is accommodated; and
a spacer arranged between the power storage module and the accommodation case, wherein
the accommodation case includes a pair of sidewalls opposed to each other in the first direction,
the spacer is arranged between at least one of the pair of sidewalls and the power storage module,
the power storage module includes an opposing portion opposed to at least one of the pair of sidewalls in the first direction,
the spacer includes an elastic first member and a second member higher in modulus of elasticity than the first member,
the first member includes a first line portion that continuously extends to form a holding region where the second member can be held,
the second member is filled in the holding region, and
the first member and the second member are sandwiched between at least one of the pair of sidewalls and the opposing portion.

2. The power storage device according to claim 1, wherein
the accommodation case includes a bottom wall portion that supports the power storage module, and
the first line portion is in a U shape that opens toward a side opposite to a side where the bottom wall portion is located.

3. The power storage device according to claim 2, wherein
the first line portion includes a pair of ends distant from each other on the side opposite to the side where the bottom wall portion is located, and
the first member includes a second line portion that extends from one end side of the pair of ends toward the other end side of the pair of ends.

4. The power storage device according to claim 2, wherein
the first line portion includes
a pair of first extension portions that is arranged as being aligned at a distance in a second direction orthogonal to the first direction and a direction perpendicular to the bottom wall portion and extends along the direction perpendicular to the bottom wall portion,
a second extension portion that extends along the second direction on a side of the bottom wall portion relative to the pair of first extension portions, and
a corner portion that connects an end of each of the pair of first extension portions located on the side of the bottom wall portion and the second extension portion to each other, and
the corner portion includes
an inner curved portion that forms a part of an inside edge portion of the U shape, and
an outer curved portion that forms a part of an outside edge portion of the U shape.

5. The power storage device according to claim 4, wherein
the inner curved portion is larger in radius of curvature than the outer curved portion.

6. The power storage device according to claim 1, wherein
the second member includes a portion that continuously extends along an inner edge portion of the first line portion.

7. A method of manufacturing a power storage device comprising:
preparing a case member including a pair of sidewalls opposed to each other in a first direction and a bottom wall portion to which the pair of sidewalls is connected;
arranging a power storage module including a plurality of power storage cells aligned in the first direction on the bottom wall portion; and
providing a spacer for suppression of expansion of the power storage module between at least one of the pair of sidewalls and the power storage module, wherein
the providing a spacer includes
providing an elastic first member, and
providing a second member higher in modulus of elasticity than the first member,
the providing an elastic first member includes expanding the first member provided as being expandable at an opposing portion of the power storage module opposed to at least one of the pair of sidewalls in the first direction,
in the expanding the first member, the first member is expanded to form a holding region where the second member in a fluid state can be held,
the providing a second member includes
filling the second member in the fluid state in the holding region, and
solidifying the second member in the fluid state, and
the first member and the second member are formed as being sandwiched between at least one of the pair of sidewalls and the opposing portion.

8. The method of manufacturing a power storage device according to claim 7, wherein
the first member is provided at the opposing portion to include a first line portion in a U shape that opens toward a side opposite to a side where the bottom wall portion is located.

9. The method of manufacturing a power storage device according to claim 8, wherein
the first member is formed to include the first line portion in the U shape including a pair of ends located as being distant from each other on the side opposite to the side where the bottom wall portion is located and a second line portion that extends from one end side of the pair of ends toward the other end side of the pair of ends.

10. The method of manufacturing a power storage device according to claim 8, wherein
the first line portion is provided to include
a pair of first extension portions that is arranged as being aligned at a distance in a second direction orthogonal to the first direction and a direction perpendicular to the bottom wall portion and extends along the direction perpendicular to the bottom wall portion,
a second extension portion that extends along the second direction on a side of the bottom wall portion relative to the pair of first extension portions, and
a corner portion that connects an end of each of the pair of first extension portions located on the side of the bottom wall portion and the second extension portion to each other, and
the corner portion is provided to include
an inner curved portion that forms a part of an inside edge portion of the U shape, and
an outer curved portion that forms a part of an outside edge portion of the U shape.

11. The method of manufacturing a power storage device according to claim 10, wherein
the inner curved portion is larger in radius of curvature than the outer curved portion.

12. The method of manufacturing a power storage device according to claim 7, wherein
in the preparing a case member, the case member provided with a through hole that passes through in the first direction in a portion of at least one of the pair of sidewalls opposed to the holding region is prepared, and
in the filling the second member in the fluid state, the second member in the fluid state is injected into the holding region through the through hole.

13. The method of manufacturing a power storage device according to claim 7, wherein
the arranging a power storage module on the bottom wall portion includes
applying an adhesive to at least a part of an opposing surface of the power storage module to be opposed to the bottom wall portion, and
pressing the power storage module relatively against the bottom wall portion with the adhesive being interposed, and
in the expanding the first member, the first member is expanded as being distant from the adhesive.

14. The method of manufacturing a power storage device according to claim 13, wherein
in a state before expansion of the first member, the first member is located at a prescribed distance from the bottom wall portion, and
the prescribed distance is at least 0.8% and at most 8% of a height of the power storage cells in a direction perpendicular to the bottom wall portion.

15. The method of manufacturing a power storage device according to claim 7, wherein
in the arranging a power storage module on the bottom wall portion, the first member is provided at the opposing portion of the power storage module, as being scaled at a barometric pressure lower than an atmospheric pressure by a scaling member, and
in the expanding the first member, the first member is expanded by providing an opening in the sealing member.
